(19) United States
(12) Patent Application Publication
(10) Pub. No.: US 2025/0083289 A1
(43) Pub. Date: Mar. 13, 2025

(54) CHAIN RESTRAINT

(71) Applicant: Wireman Pty Limited, Milsons Point NSW (AU)

(72) Inventor: Ian Lowrey, Lane Cove West NSW (AU)

(21) Appl. No.: 18/824,131

(22) Filed: Sep. 4, 2024

(30) Foreign Application Priority Data
Sep. 13, 2023 (AU) 2023902942

(51) Int. Cl. B25B 25/00

(52) U.S. Cl. CPC B25B 25/00

(57) ABSTRACT

A chain restraint for a pawl operated wire strainer is disclosed. The wire strainer (100) has a handle (11) with a walker bar (12) extending from the handle (11), and a pair of pawls (13,14) pivoted on the walker bar (12). The walker bar (12) and pawls (13,14) substantially define an operating plane (18,19) of the wire strainer (10), wherein said chain restraint (30) comprises a protrusion extending outwardly from said operating plane (18,19). A wire strainer (100) having at least one chain restraint (30) is also disclosed.

### FIELD OF THE INVENTION

The present invention relates to agricultural wire strainers and, in particular, to agricultural wire strainers which “walk” along a chain due to the action of pawls attached to a reciprocating walker bar.

### BACKGROUND ART

Such wire strainers generally take the form of a handle, a walker bar extending from the handle, and a pair of pawls pivoted on the walker bar. By moving the handle backwards and forwards through an arc, so the pawls can be made to walk along the chain.

The chain over which the pawls have already moved in order to carry out the straining motion, cascades over the strainer under the influence of gravity. Since the strainer may be held in various orientations depending upon the height of the wire being strained, the height of the fencing contractor or farmer, the stance of the fencing contractor or farmer, and the like, so the chain over which the pawls have already moved may cascade in various different fashions.

When the strainer is moving forwardly along the chain, the chain about to be engaged by the pawls is relatively taut and straight and untwisted. It is necessary for the chain to be untwisted (that is having the chain links aligned) for the pawls to walk along the chain. For this reason a swivel (not illustrated) is often located in the chain. A difficulty sometimes arises when the strainer is being released after the wires being strained are interconnected, in that the pawls are required to walk backwardly for at least a small distance, and this is difficult if the un-tensioned chain is not straight and untwisted.

### Genesis of the Invention

The genesis of the present invention is a desire to at least ameliorate the above-mentioned difficulty.

It is known from Australian Patent Application No 2008 203 804 in the name of Peter Barrett to provide a guide means 33 which provides a guiding influence to the “excess chain” over which the pawls have walked. The main constituent of this guide means 33 is a notch 38 in the walker bar 30 (FIG. 5 of the abovementioned Australian patent application).

It is also known from Australian Patent Application No 2018 274 897 ONESTEEL WIRE PTY LIMITED to provide similar notches 24, 224, 225, 226 in a walker bar of a wire strainer. Although provided to increase the arc through which the handle can be reciprocated, such notches also provide a guiding influence for the “excess chain” over which the pawls have already walked.

### SUMMARY OF THE INVENTION

In accordance with a first aspect of the present invention there is disclosed a chain restraint for a pawl operated wire strainer having a handle, a walker bar extending from the handle, and a pair of pawls pivoted on the walker bar, the walker bar and pawls substantially defining an operating plane of said wire strainer, wherein said chain restraint comprises a protrusion extending outwardly from said operating plane.

### BRIEF DESCRIPTION OF THE DRAWINGS

A preferred embodiment of the invention will now be described, by way of example only, with reference to the accompanying drawings in which:

FIG. 1 is a partial perspective view of a prior art fence strainer illustrating the handle, walker bar, pawls and coupling links,

FIG. 2 is a top view of the prior art fence strainer of FIG. 1,

FIG. 3 is a perspective view of a prior art fence strainer in one mode of operation,

FIG. 4 is a perspective view of the prior art fence strainer of FIG. 3 in another mode of operation,

FIG. 5 is a front perspective view of a chain restraining link of a first embodiment,

FIG. 6 is a rear perspective view of the chain restraining link of FIG. 5,

FIG. 7 is a perspective view similar to FIG. 3 of a fence strainer having two of the chain restraining links of FIGS. 5 and 6,

FIG. 8 is a perspective view similar to FIG. 4 of the fence strainer of FIG. 7,

FIG. 9 is an enlarged perspective view of the fence strainer of FIG. 8,

FIG. 10 is a view similar to FIG. 9 but showing the fence strainer in an inverted position, and

FIG. 11 is a view similar to FIG. 9 but showing the strainer being partially released from the chain.

### DETAILED DESCRIPTION

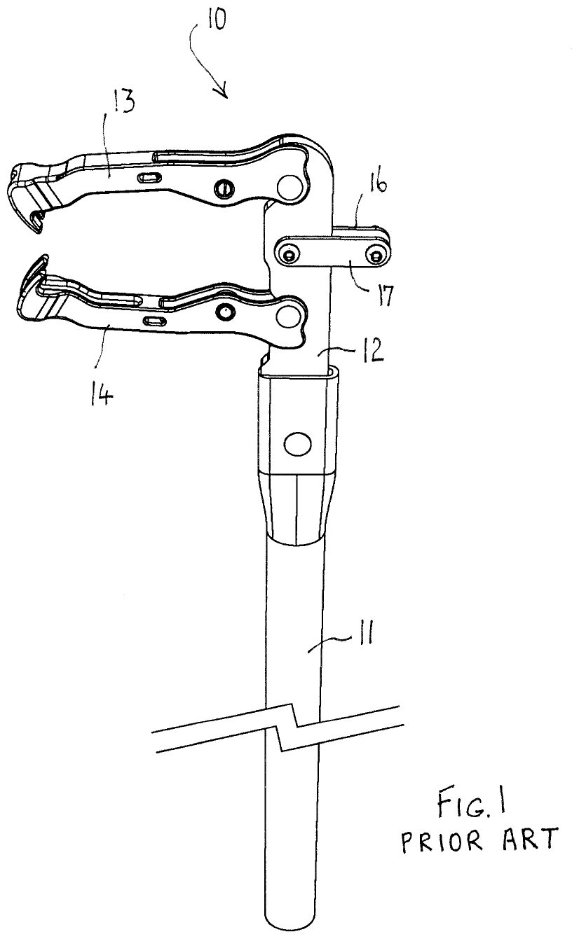

As seen in FIG. 1, a prior art fence strainer 10 has a handle 11 of indefinite length from which extends a walker bar 12. Two pawls 13, 14 are pivoted on the walker bar 12. In between the pawls 13, 14 are two connecting links 16 and 17 which connect to a hook, strain gauge, wire gripper or the like (all not illustrated in FIG. 1) depending upon the configuration of the strainer 10.

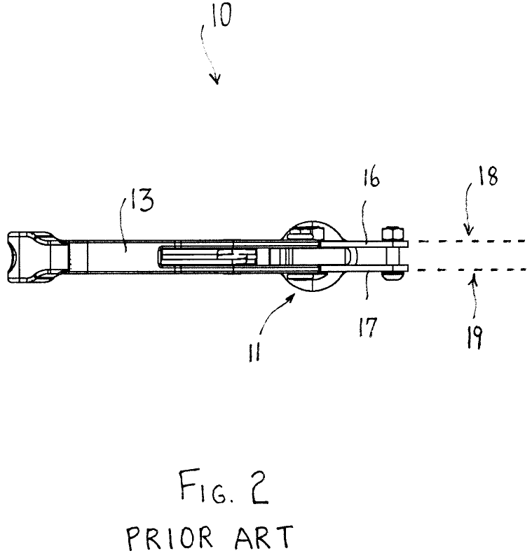

From FIG. 2, it will be seen that the connecting links 16, 17 are substantially flush with the side surfaces of the pawls 13, 14 and define a pair of operating planes 18, 19 which will be referred to hereafter.

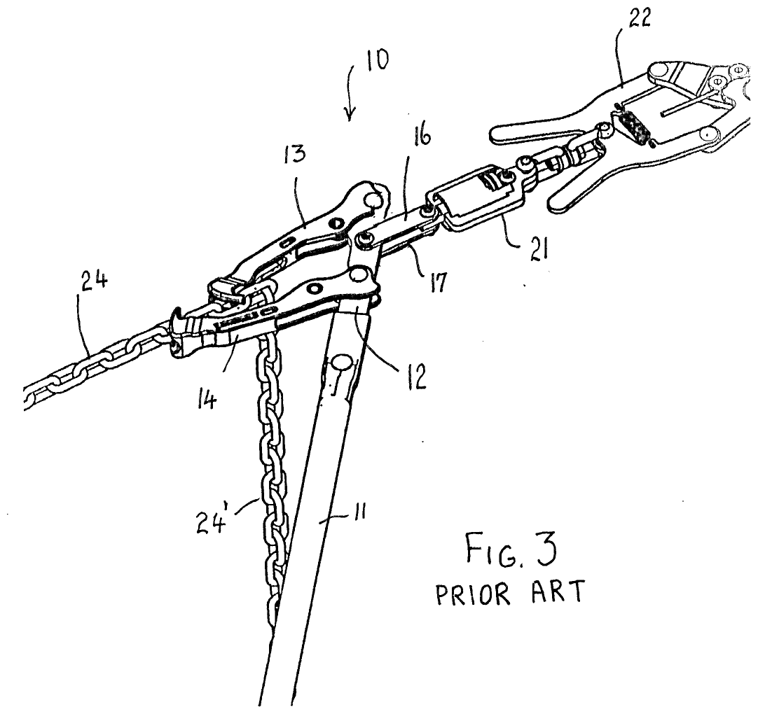

Turning now to FIG. 3, the connecting links 16, 17 of the fence strainer 10 are connected to a conventional strain gauge 21 which is in turn connected to a conventional wire grabber or gripper 22. The strain gauge 21 is preferably of the type illustrated in Australian Design Registration No 2020 15808 and the wire gripper 22 is preferably of the type illustrated in U.S. Pat. No. 11,680,422. The pawls 13, 14 are inter-engaged with a chain 24 and can be walked along the chain 24 by reciprocally moving the handle 11 through an arc in known fashion. In the mode of operation illustrated in FIG. 3, the “excess” chain 24′ (which is the chain upon which the pawls 13, 14 have already walked) drops down between the pawls 13, 14.

However, in the mode of operation illustrated in FIG. 4, the same excess chain 24′ passes over the walker bar 12 and the upper one of the two connecting links 16, 17 and then drops down under the influence of gravity. It will be appreciated that the configuration of the excess chain 24′ in the arrangement illustrated in FIG. 4 is very dependent upon the orientation of the fence strainer 10. For example, if the handle 11 is lifted upwardly, then the “excess” chain 24′ can drop over the distal pawl 13.

After the fence wire has been strained, and often knotted or otherwise secured by means of a fastener such as those sold under the trade marks GRIPPLE or BOBEX, it then becomes necessary to remove the strainer 10 from the chain 24. This is done by, paradoxically, increasing the strain and removing the leading pawl (14 in FIGS. 3 and 4) from engagement with the chain 24. This action requires the previously leading pawl to be disengaged from the chain and re-engaged behind what was the trailing pawl. This requires manual intervention in the case of the mode of operation illustrated in FIG. 3, and is difficult to do in the mode of operation illustrated in FIG. 4 if the chain 24 between the pawls 13,14 is not straight and untwisted. It is towards ameliorating this difficulty that the present invention is directed.

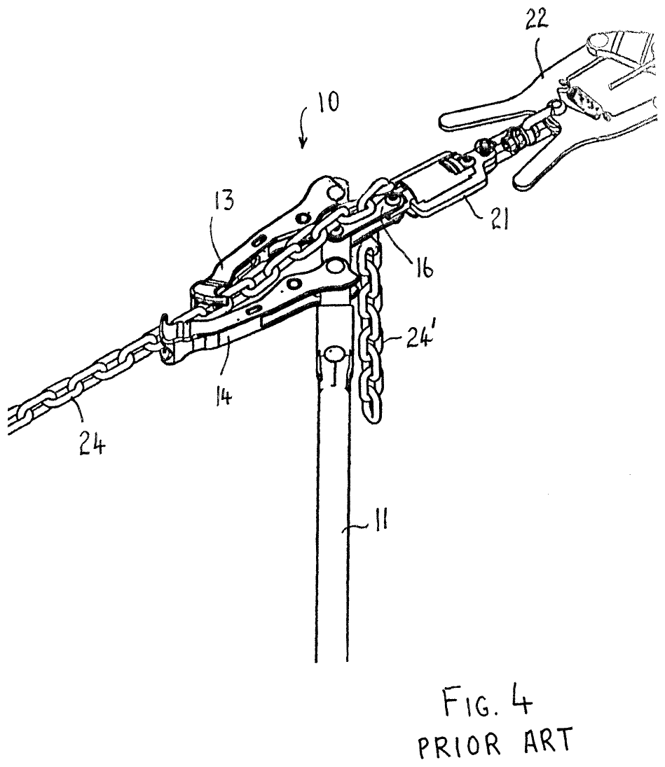

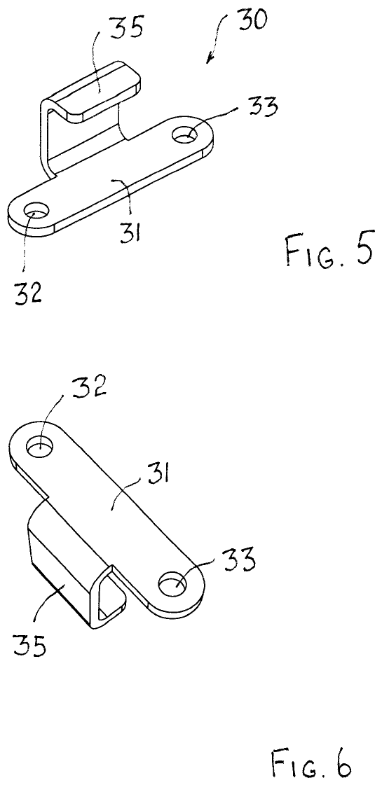

As illustrated in FIGS. 5 and 6, a chain restraint 30 is illustrated which is incorporated into a connecting link which replaces the connecting link 16, 17. It will be seen that the chain restraint 30 has a link body 31 with apertures 32, 33 in either end. In addition, the chain restraint 30 has an inverted L-shaped arm 35 which preferably has a length which exceeds the length of one of the links in the chain 24.

As seen in FIG. 7, a strainer 100 of the preferred embodiment preferably has two of the chain restraints 30 which replace the connecting links 16, 17 and thus interconnect the walker bar 12 with the strain gauge 21.

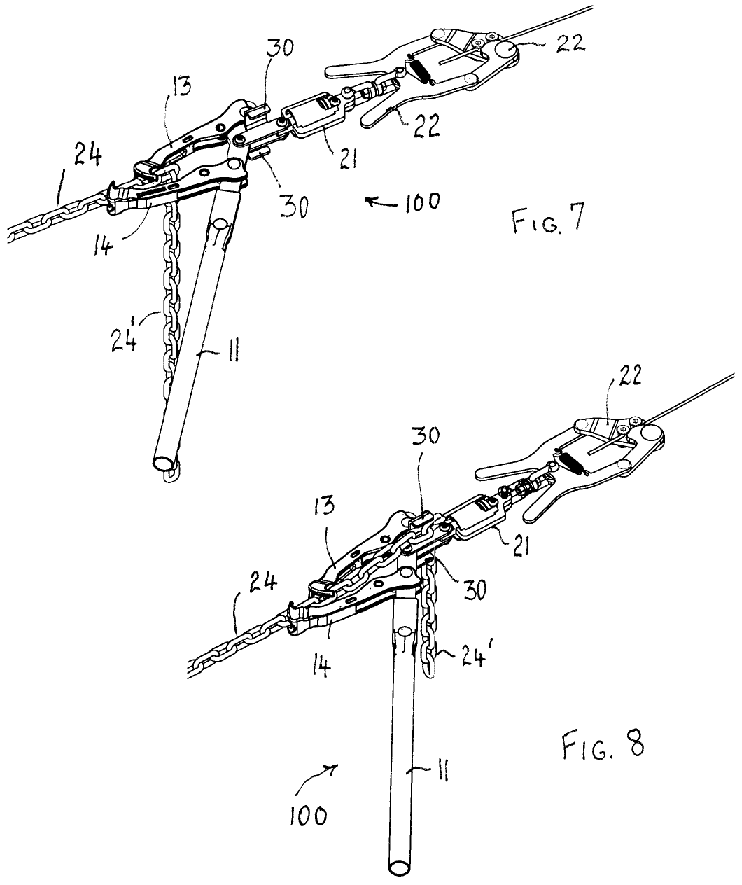

The chain restraints 30 enable the chain 24 to be passed between the link body 31 and the arm 35 and then draped downwardly under the influence of gravity as illustrated in FIG. 8. As a consequence, the chain 24″ between the trailing pawl 13 and the chain restraint 30 is maintained both straight and untwisted as it is being fed into the pawls. It will be appreciated from FIG. 8 that as the pawls 13, 14 walk along the chain 24 and thereby increase the tension in the chain 24, that portion of the chain 24″ between the chain restraint 30 and the nearer pawl 13, 14 will retain the straight and untwisted character which it had prior to being walked over by the pawls 13, 14. This is because the arm 35 of the chain restraint 30 provides a chain guide.

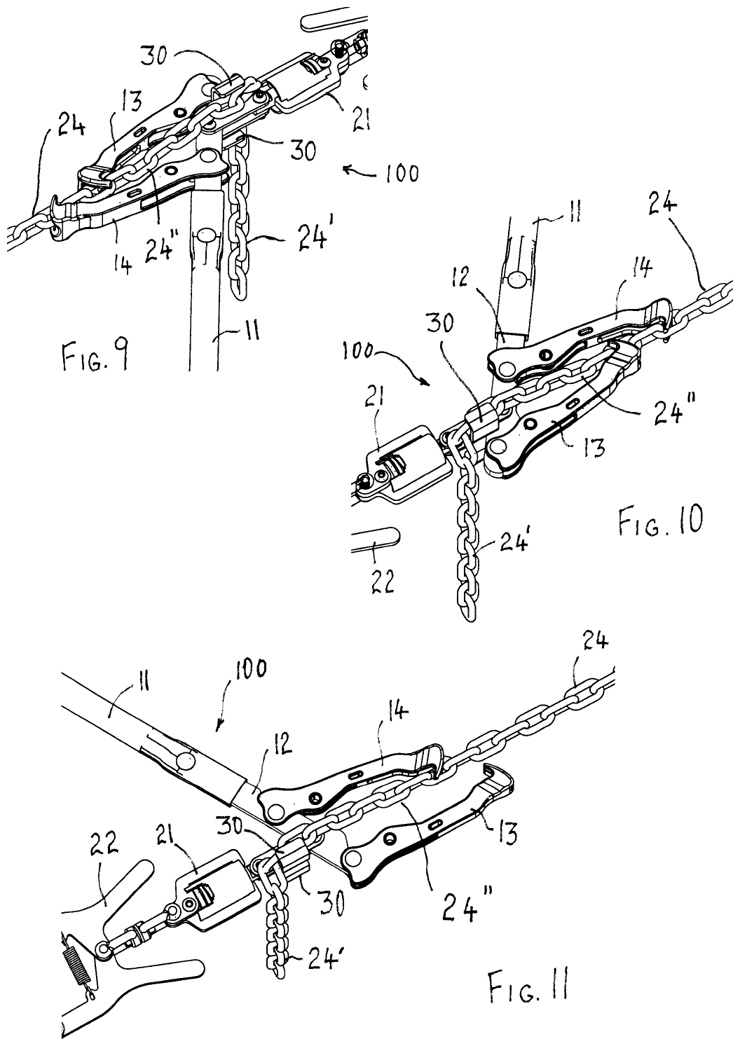

As seen in FIG. 10, the orientation of the fence strainer 100 and, in particular its handle 11, can be changed without dislodging the chain 24″ from the chain restraint 30. This is particularly important when working with wires closely adjacent the ground where, in effect, it is necessary to invert the normal operation of the fence strainer 100. If the handle 11 is not pointing generally upwards, it is unable to be reciprocated, and the strainer 100 thereby operated.

Irrespective of the orientation of the fence strainer 100, gravity always acts downwardly on the excess chain 24′ on the side of the chain restraint 30 further from the walker bar 12. As a consequence, the fence strainer 100 and its handle 11 can be moved into a variety of configurations without dislodging the excess chain 24′ from the chain restraint 30. Thus, the chain 24″ between the chain restraint 30 and the pawls 13, 14 always remains taut, straight and untwisted.

It will be apparent that the arm 35 of the chain restraints 30 extend or protrude beyond the operating planes 18, 19 as illustrated in FIG. 2. The arms 35 therefore constitute two protrusions which extend outwardly beyond the respective operating planes and in opposite directions.

The foregoing describes only one embodiment of the present invention and modifications, obvious to those skilled in the fencing arts, can be made thereto without departing from the scope of the present invention. For example, the features and advantages disclosed to one facet of the invention may be utilised, mutatis mutandis, in other facets of the invention.

It will be apparent to those skilled in the fencing arts that although two of the chain restraints 30 are preferable, most of the operational benefits can be achieved by means of a single chain restraint 30.

Furthermore, it is not necessary for the chain restraint to have the configuration of replacing a connecting link 16, 17 since a protrusion could be directly connected to, or formed on, the walker bar 12. However, a particular advantage of the chain restraint 30 of the preferred embodiment is that it is able to be retrofitted to existing fence strainers which are already in the hands of previous customers.

The term “comprising” (and its grammatical variations) as used herein is used in the inclusive sense of “including” or “having” and not in the exclusive sense of “consisting only of”.

1. A chain restraint for a pawl operated wire strainer having a handle, a walker bar extending from the handle, and a pair of pawls pivoted on the walker bar, the walker bar and pawls substantially defining an operating plane of said wire strainer, wherein said chain restraint comprises a protrusion extending outwardly from said operating plane.

2. The chain restraint as defined in claim 1 wherein said protrusion is formed on a link interconnecting said walker bar with a strain gauge, or a wire gripper or a hook.

3. The chain restraint as defined in claim 2 wherein said protrusion comprises an arm of substantially inverted L-shaped configuration.

4. The chain restraint as defined in claim 3 wherein said arm has a transverse extent approximately equal to the length of one link of the chain.

5. The chain restraint as defined in claim 1 and having a pair of said protrusions each extending from said plane in opposite directions.

6. The chain restraint as defined in claim 5 wherein each of said protrusions is formed on a corresponding one of a pair of links.

7. The chain restraint as defined in claim 6 wherein each of said protrusions comprises an arm of substantially inverted L-shaped configuration.

8. The chain restraint as defined in claim 7 wherein said arm has a transverse extent approximately equal to the length of one link of said chain.

9. A pawl operated chain walking wire strainer including at least one chain restraint as claimed in claim 1.

10. The strainer as claimed in claim 9 and including a pair of said chain restraints facing in opposite directions and each being as claimed in claim 1.
